(19) United States
(12) Patent Application Publication
(10) Pub. No.: US 2004/0212724 A1
(43) Pub. Date: Oct. 28, 2004

(54) Imaging device with liquid crystal shutter

(76) Inventors: Edward J. Bawolek, Chandler, AZ (US); Kabul Sengupta, Tempe, AZ (US); Tonia G. Morris, Chandler, AZ (US)

Correspondence Address: Timothy N. Trop, TROP, PRUNER, HU & MILES, P.C., Ste.100, 8554 Katy Freeway, Houston, TX, 77024, US

(21) Appl. No.: 10/844,868

(22) Filed: May 13, 2004

Related U.S. Application Data
(63) Continuation of application No. 09/365,313, filed on Jul. 30, 1999.

(51) Int. Cl. H04N 5/238

(52) U.S. Cl. 348/363

(57) ABSTRACT

An imaging device may include a package which mounts a liquid crystal shutter and a imaging sensor in an advantageous relationship to provide a compact footprint and improved connectability between the shutter, the imaging sensor and other components of the imaging device. The package may include a first surface which electrically couples the imaging sensor and a second surface which mounts the liquid crystal shutter. Flexible contact pins may be provided on an upper surface of the package to electrically couple the liquid crystal shutter.

### BACKGROUND

This invention relates generally to imaging devices such as those used in cameras, scanners, and the like.

Liquid crystal color filters may be used to produce a switchable shutter made up of a pair of serially arranged filters. The filters are electronically switchable because they include an electronically controllable liquid crystal element. By electrically controlling the polarization of the liquid crystal element, the light which is transmitted through the filter may be controlled.

In this way, a given wavelength band may be transmitted through a given filter. In effect, the liquid crystal color filter may be tuned to a particular color. The pair of liquid crystal color filters may be tuned to a pair of colors and through color combination, may produce a third color. Thus, a liquid crystal color filter may form a switchable shutter which can controllably produce red, green and blue primary color bands or complementary color bands such as cyan, magenta and yellow.

Switchable shutters are commercially available. One commercially available switchable shutter is the KALA switchable shutter produced by ColorLink, Inc., Boulder, Colo. 80301. See U.S. Pat. No. 5,619,355 to Sharp et al. A tunable color filter which may be used as one of the filters of a switchable shutter is described in U.S. Pat. No. 5,689,317 issued to Miller.

Switchable shutters may be used in color imaging systems to provide electronically switched color planes. In this way, each image sensor, selectively exposed to a particular color plane at one instance, may be exposed at sequential instances to successive color planes. Individual sensors are not necessary for each color plane but instead a single set of sensors may be used to sense each color plane in successive time intervals.

Thus, while switchable shutters and liquid crystal color filters offer important advantages, there is a continuing need for improved systems which may make these shutters and/or filters more advantageous in connection with digital imaging systems.

### SUMMARY

In accordance with one aspect, an imaging device includes a package having first and second electrical contacts. An imaging sensor is mounted in the package and coupled to the first contact. A liquid crystal shutter is mounted in the package over the sensor. The shutter is coupled to the second contact.

### BRIEF DESCRIPTION OF THE DRAWINGS

FIG. 1 is a schematic depiction of an imaging system using a liquid crystal filter in a switchable shutter system;

FIG. 2 is an enlarged cross-sectional view of an imaging device in accordance with one embodiment of the present invention;

FIG. 3 is an enlarged cross-sectional view of an imaging device in accordance with another embodiment of the present invention; and

FIG. 4 is a plot showing the time sequencing of color planes in one embodiment of the present invention.

### DETAILED DESCRIPTION

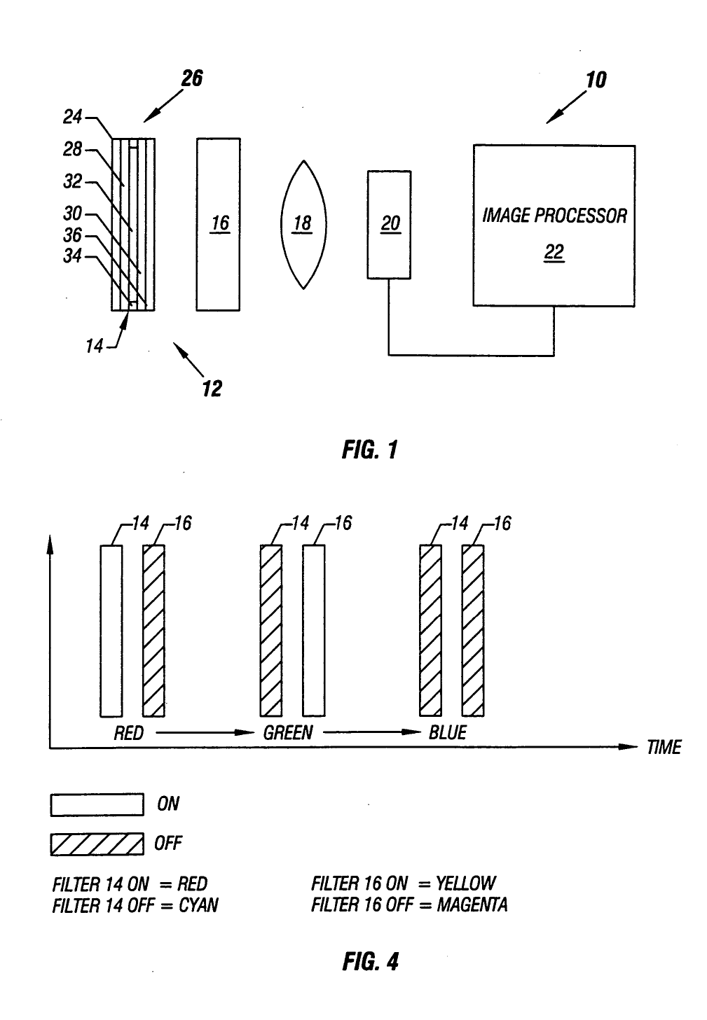

Referring to FIG. 1, an imaging device 10 which may be used for example in connection with a digital camera, a scanner, or similar devices, includes a switchable shutter 12 which sequentially passes each of a plurality of color planes, such as red, green and blue color planes. The switchable shutter 12 is tunable to produce a variety of different colors and may be used in known color systems including the red, green, blue (RGB), and the cyan, magenta, yellow (CMY) systems.

In general, when an appropriate electrical signal is applied to the switchable shutter 12, it is tuned to pass a particular color plane. Therefore, the shutter may be sequentially tuned to pass each of the three conventional color planes which may then be detected by an imaging sensor 20. The imaging sensor 20 may be a complementary metal oxide semiconductor (CMOS) image sensor which uses either an active pixel sensor (APS), a passive pixel sensor (PPS) system or other known techniques. Alternatively, a charge coupled device (CCD) sensor may be used.

The switchable shutter 12 provides electronically alterable transmission spectra in different color bands. One switchable color shutter uses a KALA filter available from ColorLink, Inc. of Boulder, Colo. 80301. The shutter 12 is synchronously switched to successively provide color information in each of the desired bands. The KALA filter switches between an additive primary color (RGB) and a complementary substrate primary color (CMY). Input white light is converted to orthogonally polarized complementary colors.

The color shutter is electronically switchable between transmission spectra centered in each of a plurality of additive color planes such as the red, green and blue (RGB) primary color planes. The color shutter may be sequentially switched to provide three color planes that are combined to create a three color representation of an image.

Thus, the use of color shutters in imaging systems may advantageously allow each pixel image sensor to successively respond to each of the three color bands. Otherwise, separate pixel image sensors must be interspersed in the array for each of the necessary color bands. Then, the missing information for each pixel site, for the remaining two color planes, is deduced using interpolation techniques. With the color shutter, every pixel can detect each of the three color bands, which should increase spatial resolution without interpolation.

A conventional lens system 18 may be provided between an imaging sensor 20 and the switchable shutter 12. The imaging sensor 20 communicates with a conventional image processor 22 in a known fashion.

Advantageously, the switchable shutter 12 is made up of a pair of liquid crystal color filters 14 and 16. For example, the filter 14 may provide a red/cyan stage while the filter 16 may provide a magenta/yellow stage. The color shutter 12 then may selectively provide three additive color bands as well as a black state.

Each filter 14 or 16 may be composed of three elements. The element 24 may be neutral linear polarizer. Neutral linear polarizers are commercially available from a variety of companies including Polaroid Corporation of Cambridge, Mass. Behind the polarizer may be liquid crystal 26. Behind the liquid crystal 26 may be a color selective polarizer 36. The color selective polarizer 36 may be made of a dyed, oriented polyvinyl alcohol (PVA) material. These devices are known in the art.

The liquid crystal 26 may include a pair of glass substrates 28 and 30 which may, for example, be made of borosilicate glass. A liquid crystal material 32 may then be contained between the layers of substrate 28 and 30 as defined by the spacers 34.

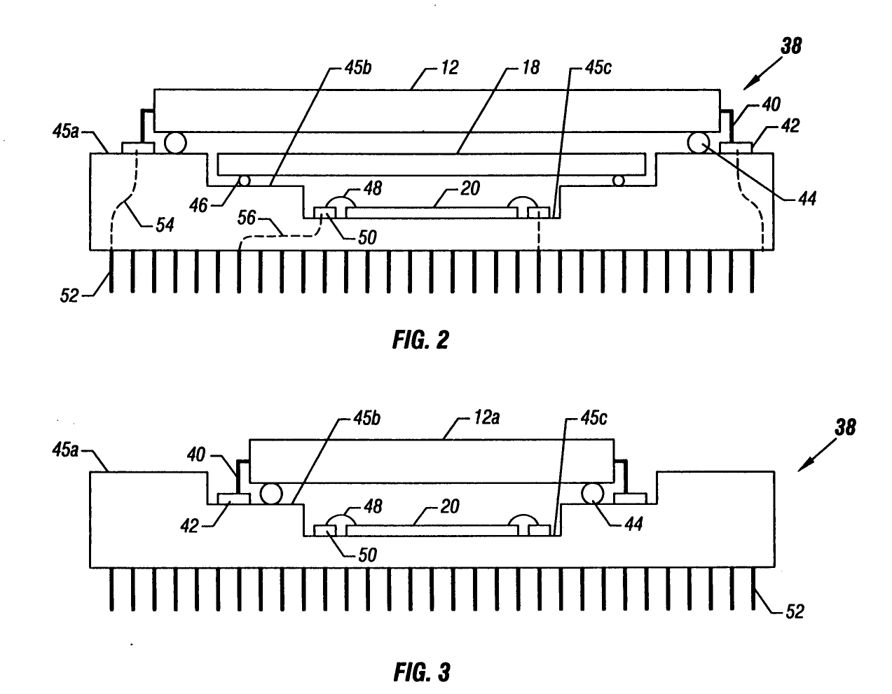

Referring now to FIG. 2, a liquid crystal shutter 12 may be mounted over the imaging sensor 20 in a package 38. The package 38 in one embodiment of the present invention may be a ceramic package but other package formats may be utilized as well. In one embodiment of the invention, the package 38 may include three vertically spaced shelves or levels 45 which may progressively decrease in size moving from top to bottom.

The liquid crystal shutter 12, mounted on the upper shelf 45a, may be coupled by flexible electrical contacts 40 to electrical contacts 42 on the package 38. The electrical contacts 40, for example, may be spring biased electrical contacts such as pogo pins. An adhesive 44 such as epoxy may secure the liquid crystal shutter 12 to the shelf 45a of the package 38.

Below the shutter 12, a clear window 18 is mounted on the intermediate shelf 45b and secured thereto using a bead of adhesive such as epoxy adhesive 46. Other securement methods may also be used. The window 18 may be made of a transparent material and in one embodiment may provide an optical lens. The window 18 may comprise a flat lens such as a Fresnel lens in one embodiment. The window 18 may also provide added hermetic isolation and thereby improve the reliability of the imaging sensor 20. In addition, the window may also include an infrared blocking filter.

Bond wires 48 may couple the sensor 20 to contacts 50 on the lower shelf 45c. The contacts 50 ultimately couple via lines 56 with one or more pins 52 on the bottom of the package 38. Similarly, the contacts 42 may be coupled to pins 52 over lines 54 which extend through the package 38.

While a pin grid array (PGA) package with pins 52 is illustrated, a ball grid array (BGA) package, for example such as a flip chip or chip on board (COB) configuration, may also be used. Alternatively, column grid array (CGA) technology may use compliant solder columns.

A compact structure may be achieved in an arrangement which decreases the amount of surface area consumed on a printed circuit board or other mounting surface (not shown). In addition, the liquid crystal shutter 12 may be precisely positioned with respect to the sensor 20. By reducing the number of parts that must be assembled to make the overall imaging device, the cost of the system may be decreased. In addition, the electrical connection of the shutter to the rest of the system may be improved by providing the contacts on the top of the package 38.

The system may be particularly applicable to focal plane processors since it decreases the demands on the imaging sensor and the focal plane processor. For example, in one embodiment the sensor 20 may be integrated into the image processor 22. In other embodiments, the processor 22 may be a separate die which is either part of the package 38 or separate therefrom.

Another embodiment of the present invention, shown in FIG. 3, includes a liquid crystal shutter 12a which is generally similar to the device shown in FIG. 2 but is illustrated as being of a smaller size. The shutter 12a may be mounted on the intermediate shelf 45b in the package 38 and the window 18 may be eliminated. The shutter 12a may electrically couple to the pins 52 through the package 38. Again, a pogo pin electrical coupling may be implemented by contacts 40 and 42.

In this case, the shutter 12a acts as a lid for the package 38 and it may be hermetically sealed to the shelf 45b, for example using adhesive. By eliminating the window 18, two surfaces may be removed from the optical path. In some embodiments, this may reduce reflective losses. If desired, an optical element may be provided externally to the package 38.

Referring now to FIG. 4, the time sequential operation of the liquid crystal shutter 12 is illustrated. In the illustrated embodiment, the shutter 12 produces a time spaced sequence of red, green and blue color information. Thus, the red plane is passed by the shutter at a first time interval, the green plane is passed at a second time interval and the blue plane is passed at a third time interval, in one embodiment of the present invention. The time sequencing of color planes repeats each time an image is to be captured.

In one embodiment of the invention, the color filter 14 may be a filter which passes red light when it is “on” and cyan when it is “off”. Similarly, the filter 16 may pass yellow light when it is “on” and magenta light when it is “off”. Again, the filters 14 and 16 may be turned “on” and “off” by applying appropriate electrical signals. Thus, the combination of the filter 14 being “on” and the filter 16 being “off” produces red light, while the filter 14 being “off” and the filter 16 being “on” produces green light. Finally when both filters are off, blue light results in the illustrated embodiment.

Of course, other colors and color planes may be produced using a variety of shutters. In the illustrated embodiment, two filters produce three color planes. In the example illustrated in FIG. 4, the system is based on the color red but other filter schemes using blue or green may also be used.

The color shutters may use cholesteric materials as described in U.S. Pat. No. 5,619,355 to Sharp. In this type of device, illustrated in FIG. 4, blue light is transmitted when both elements are in the off state. Alternatively, smectic and/or chiral smectic liquid crystal material shutters may be used, as described in U.S. Pat. Nos. 5,132,826, 5,231,521 and 5,243,455 to Johnson.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An imaging device comprising:
a package having first and second electrical contacts;
an imaging sensor mounted in said package and coupled to said first contact;
a liquid crystal shutter mounted in said package over said sensor, said shutter coupled to said second contact; and
a transparent window between said liquid crystal shutter and said imaging sensor, said transparent window mounted in said package, said window being a diffractive, flat lens.

2. The device of claim 1 wherein said package includes a pair of vertically spaced surfaces, said imaging sensor mounted on one of said surfaces and said liquid crystal shutter mounted on the other of said surfaces.

3. The device of claim 1 wherein said package is a ceramic package.

4. The device of claim 2, said package further including a third surface, said third surface mounting said window between said liquid crystal shutter and said imaging sensor.

5. The device of claim 4 wherein said window is a Fresnel lens.

6. The device of claim 4 wherein said window is hermetically sealed to said package.

7. The device of claim 1 wherein said liquid crystal shutter is electrically coupled to said second contact on the top of said package.

8. The device of claim 7 wherein said liquid crystal shutter is coupled to said second contact through a flexible electrical coupling.

9. The device of claim 8 wherein said flexible electrical coupling includes a pogo pin.

10.-20. (Canceled)
